(19) United States
(12) Patent Application Publication
(10) Pub. No.: US 2026/0128306 A1
(43) Pub. Date: May 7, 2026

(54) LMFP COMPOSITE POSITIVE ELECTRODE PARTICLE WITH HIGH PERFORMANCE CONDUCTIVE CARBON STRUCTURE

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen (CN)

(21) Appl. No.: 18/939,550

(22) Filed: Nov. 7, 2024

(51) Int. Cl. H01M 4/58; H01M 4/02; H01M 4/36; H01M 4/60; H01M 4/62

(52) U.S. Cl. CPC H01M 4/5825; H01M 4/366; H01M 4/602; H01M 4/625; H01M 2004/021

(57) ABSTRACT

An LMFP composite positive electrode particle with a high performance conductive carbon structure, which is used in a positive electrode of a solid-state or semi-solid battery. The composite positive electrode particle includes an LMFP particle and a conductive layer coated on an outer surface of the LMFP particle. The conductive layer includes a plurality of carbon agglomerates, lithium ion conductor particles and conductive carbons. The carbon agglomerates are formed by a dehydration reaction of carbohydrates, water-soluble fibers or amino acid polymers. The lithium ion conductor particles are formed by a first oxide or phosphate capable of conducting lithium ions, or by a second oxide with a garnet structure or a perovskite structure. The conductive carbons are formed by at least one of graphite, graphene, nanoscale amorphous carbon, and carbon nanotube with a length less than or equal to 1 μm.

### FIELD OF THE INVENTION

The present invention is related to a positive electrode material for a battery, and in particular to an LMFP composite positive electrode particle with a high performance conductive carbon structure.

### BACKGROUND OF THE INVENTION

A typical battery includes a positive electrode and a negative electrode. A cathode of the battery is the positive electrode inside the battery. The positive electrode of a solid-state or semi-solid battery includes a positive electrode substrate and a positive electrode slurry layer. The positive electrode slurry layer includes a positive electrode slurry and a plurality of positive electrode particles. The positive electrode particles must be either additionally conductive or electrically conductive to allow free electrons to migrate through the positive electrode slurry without consuming too much energy due to internal resistance. Material of the positive electrode particles may be LMFP (lithium manganese iron phosphate), which has a better working voltage performance than LFP (lithium iron phosphate), releases higher energy density, is inexpensive, and is hydrophobic.

However, LMFP has a poor charge-discharge rate performance and a lower lithium ion conductivity and electrical conductivity, and it is prone to deterioration under prolonged battery use. Although there are many ways to increase the lithium ion conductivity of positive electrode particles, the electrical conductivity is still insufficient for practical use.

Therefore, the present invention desires to provide a novel invention to increase the electrical capacity and electrical conductivity of positive electrode of solid-state or semi-solid battery.

### SUMMARY OF THE INVENTION

Accordingly, for improving above mentioned defects in the prior art, the object of the present invention is to provide an LMFP composite positive electrode particle with a high performance conductive carbon structure, wherein the LMFP particle is coated by a conductive layer to increase the overall performance. The cost of LMFP is lower than the ternary oxide and the charge and discharge performance of LMFP can be applied to a specific range of applications. The conductive layer on the outer surface of the LMFP particle compensates for the lower conductivity of LMFP, and the LMFP particle are also coated with lithium ion conductor particles to enhance the overall lithium ion conductivity and electrical conductivity, resulting in a better battery performance.

To achieve above object, the present invention provides an LMFP composite positive electrode particle with a high performance conductive carbon structure; the composite positive electrode particle being used in a positive electrode of a solid-state or semi-solid battery; the composite positive electrode particle comprising: an LMFP particle; a conductive layer coated on an outer surface of the LMFP particle; and the conductive layer including a plurality of carbon agglomerates and a plurality of lithium ion conductor particles; wherein the carbon agglomerates are formed by a dehydration reaction of carbohydrates, or are formed by carbon skeletons and functional groups formed by a dehydration reaction of water-soluble fibers, or are formed by carbon skeletons with straight chains or side chains containing doping elements by a dehydration reaction of amino acid polymers; wherein the lithium ion conductor particles are dispersed within the conductive layer, or near an outer side of the conductive layer, or near the outer surface of the LMFP particle; wherein each of the lithium ion conductor particles is formed by a first oxide or phosphate capable of conducting lithium ions, or is formed by a second oxide with a garnet structure or a perovskite structure; and wherein the conductive layer further includes a plurality of conductive carbons connected to the carbon agglomerates to cause electrons are capable of passing across different carbon agglomerates; and the conductive carbons are formed by at least one of graphite, graphene, nanoscale amorphous carbons, and carbon nanotubes with a length less than or equal to 1 μm.

### BRIEF DESCRIPTION OF THE DRAWINGS

FIG. 1 is a cross-section view showing the structure of the composite positive electrode particle of the present invention.

FIG. 2 is a schematic view showing an application of the present invention.

FIG. 3 is a schematic view showing the full structure and a partial structure of the composite positive electrode particle of the present invention.

FIG. 4 is a schematic view showing the carbon-material-coated composite positive electrode particle of the present invention.

FIG. 5 is a schematic view showing the lithium ion composite conductor particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

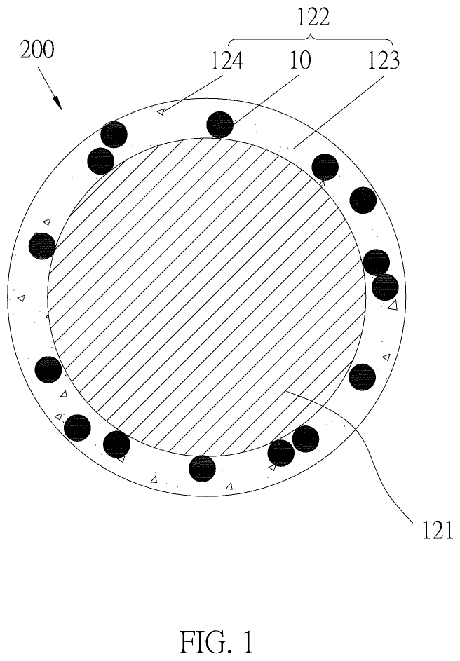

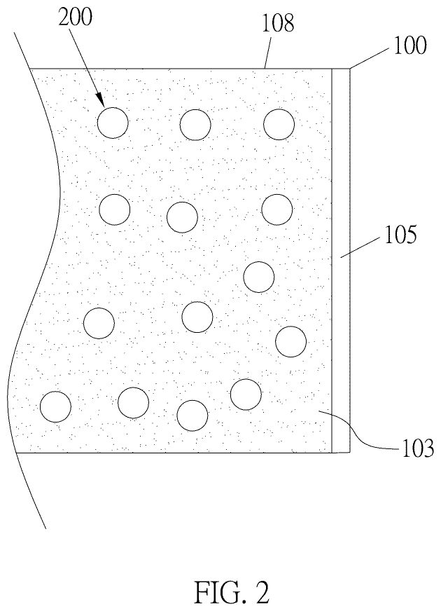

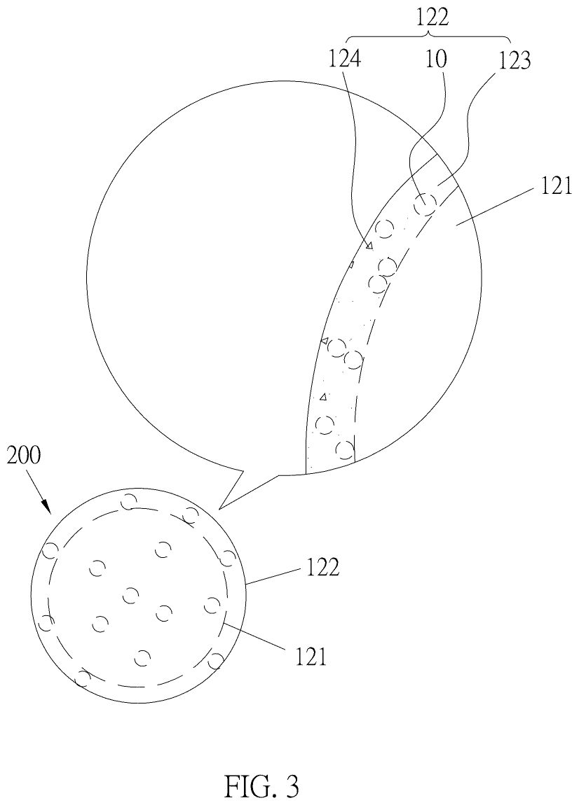

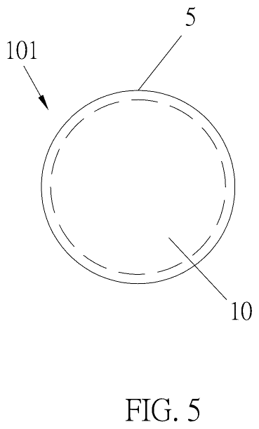

With reference to FIGS. 1 to 5, the present invention provides an LMFP composite positive electrode particle 200 with a high performance conductive carbon structure, which is used in a positive (+) electrode 100 of a solid-state or semi-solid battery. The positive electrode 100 includes a positive electrode substrate 105 and a positive electrode slurry layer 108 coated on the positive electrode substrate 105 (as shown in FIG. 2). The positive electrode slurry layer 108 includes a plurality of composite positive electrode particles 200 and a positive electrode slurry 103 having a binder. A weight percentage of the composite positive electrode particles 200 in the positive electrode slurry layer 108 is 88 wt %˜98 wt %.

Referring to FIG. 1, each of the composite positive electrode particles 200 includes the following elements.

An LMFP particle 121, wherein a D50 (mass-median-diameter, MMD) value of the LMFP particle 121 is less than 1 μm. The LMFP particle 121 is a polymer of monocrystalline materials or microcrystalline particles. The LMFP particle 121 is formed by LMFP (lithium manganese iron phosphate, LiMnₓFe₁₋ₓPO₄, 0.1≤x<0.8) or LMFP doped with at least one metal.

A conductive layer 122 is coated on an outer surface of the LMFP particle 121. The conductive layer 122 includes a plurality of carbon agglomerates 123 and a plurality of lithium ion conductor particles 10 for increasing conductivity of the composite positive electrode particle 200. The carbon agglomerates 123 are formed by a carbon source added in the manufacturing of the composite positive electrode particle 200.

The carbon agglomerates 123 are formed by an organic compound capable of forming carbons under a reduction atmosphere. The organic compound is selected from carbohydrate (such as monosaccharide, disaccharide, oligosaccharide or polysaccharide), water-soluble fiber and amino acid polymer. Preferably, the organic compound is a compound including carbon, nitrogen, fluorine, phosphorus and sulfur, wherein the nitrogen, fluorine, phosphorus and sulfur are doped to the carbon by a reduction reaction, which increases the electrical conductivity of the composite positive electrode particle 200.

Preferably, the carbon agglomerates 123 are formed by a dehydration reaction of carbohydrates, or are formed by carbon skeletons and functional groups formed by a dehydration reaction of water-soluble fibers, or are formed by carbon skeletons with straight chains or side chains containing doping elements by a dehydration reaction of amino acid polymers (such as peptide).

The conductive layer 122 further includes a plurality of conductive carbons 124 connected to the carbon agglomerates 123 to cause electrons are capable of passing across different carbon agglomerates 123 to increase the electrical conductivity. The conductive carbons 124 are formed by at least one of graphite, graphene, nanoscale amorphous carbons, and carbon nanotubes with a length less than or equal to 1 μm.

The lithium ion conductor particles 10 are dispersed within the conductive layer 122, or near an outer side of the conductive layer 122, or near the outer surface of the LMFP particle 121. A thickness of the conductive layer 122 is less than or equal to 200 nm. A size of each of the lithium ion conductor particles 10 is less than or equal to 200 nm.

Each of the lithium ion conductor particles 10 is formed by a first oxide or phosphate capable of conducting lithium ions, or is formed by a second oxide with a garnet structure or a perovskite structure. A lithium ion conductivity of the first oxide or phosphate is higher than 10⁻⁵ S/cm (Siemens per centimeter). The first oxide or phosphate with the lithium ion conductivity may be LATP (lithium aluminum titanium phosphate) with a NASICON (sodium (Na) super ionic conductor) structure, LAGP (lithium aluminium germanium phosphate), or lithiophosphate (Li₃PO₄). The second oxide with the garnet structure or the perovskite structure may be LLZO (Li₇La₃Zr₂O₁₂ lithium lanthanum zirconium oxide) or LLTO (lithium lanthanum titanium oxide). The lithium ion conductor particle 10 also can be formed by combination of above materials with any ratio.

An outer surface of each of the lithium ion conductor particles 10 is further coated by a borate layer 5 to cause that the lithium ion conductor particles 10 form a plurality of lithium ion composite conductor particles 101. The lithium ion composite conductor particles 101 on the LMFP particle 121 form a continuous layer structure or a discontinuously dispersed structure or an island-shaped structure, which is naturally formed in the manufacturing process.

In the oxygen-free sintering of manufacturing of the composite positive electrode particle 200, the conductivity of the lithium ion conductor particles 10 will be decreased due to the lithium deficiency caused by oxygen lacking. Therefore, the borate layer 5 is coated on the outer surface of the lithium ion conductor particles 10 to be used as a protective layer, which prevents the structure of the lithium ion conductor particles 10 from being damaged.

Preferably, each of the lithium ion conductor particles 10 is formed by at least one of LLZO (Li₇La₃Zr₂O₁₂), Ga-LLZO (gallium-doped LLZO), Cu-LLZO (copper-doped LLZO), Ta-LLZO (tantalum-doped LLZO), Sr-LLZO (strontium-doped LLZO) and Al-LLZO (aluminum-doped LLZO).

Preferably, each of the lithium ion conductor particles 10 is formed by Cuₐ, X_{b}-LLZO, which is LLZO doped with copper (Cu) and a metal X, wherein X is selected from gallium (Ga), tantalum (Ta), strontium (Sr), barium (Ba) and aluminum (Al), and a>0 and b>0. Preferably, a+b=0.25˜0.8 and a>0.1. Doping the copper in the LLZO is technically difficult, but Cuₐ, X_{b}-LLZO can stabilize an overall structure, smooth the channels for lithium ions, and increase a speed of the sintering, which makes the cost more cheaper. It also reduces the producing of lithium carbonate (Li₂CO₃) when being exposed to the air, which increases the surface stability during the sintering.

When each of the lithium ion conductor particles 10 is formed by LAGP or LATP, the LAGP or LATP is selected from Li₁₊ₓAlₓA₂₋ₓ(PO₄)₃ or Li_{1+x+y}AlₓA_{2-x-y-z}M_{y}N_{z}(PO₄)₃, wherein 0.1≤x≤0.8, 0≤y≤0.2, 0≤z≤0.2, A is germanium (Ge) or titanium (Ti), M is trivalent cation (such as scandium cation (Sc³⁺), yttrium cation (Y³⁺), gallium cation (Ga³⁺), indium cation (In³⁺) or lanthanum cation (La³⁺)), and N is tetravalent cation (such as zirconium cation (Zr⁴⁺), silicon cation (Si⁴⁺), or tin cation (Sn⁴⁺)).

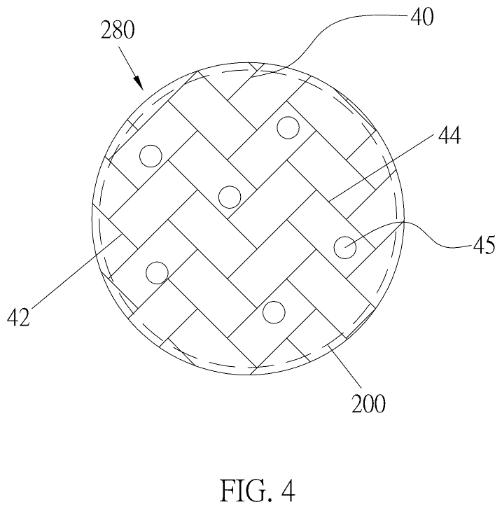

Referring to FIG. 4, an outer surface of the composite positive electrode particle 200 is coated by a carbon material to increase the conductivity. The carbon material includes a plurality of first carbon nanotubes 40 and a plurality of nanoscale amorphous carbons 45. The composite positive electrode particle 200 and the carbon material form a carbon-material-coated composite positive electrode particle 280.

The first carbon nanotubes 40 include a plurality of short chain carbon nanotubes 42 and a plurality of long chain carbon nanotubes 44. A length of each of the short chain carbon nanotubes 42 is 0.2 μm to 1 μm. A length of each of the long chain carbon nanotubes 44 is 1 μm to 3 μm. A ratio of a weight of the short chain carbon nanotubes 42 and a weight of the long chain carbon nanotubes 44 is 10:1 to 2:1. A ratio of a weight of the first carbon nanotubes 40 and a weight of the nanoscale amorphous carbons 45 is 1:1 to 1:10. A size of each of the nanoscale amorphous carbons 45 is nm to 40 nm. A quotient of a ratio of a total weight of the first carbon nanotubes 30 and the nanoscale amorphous carbons 45 and a weight of the composite positive electrode particle 200 is less than or equal to 0.01; that is, the ratio is not higher than 1:100.

Different lengths of the first carbon nanotubes 40 form different levels of spanning on the composite positive electrode particle 200. The short chain carbon nanotubes 42 are connected across between the lithium ion conductor particles 10 and the LMFP particle 121. The long chain carbon nanotubes 44 cover the composite positive electrode particle 200 to enhance a structural strength of the composite positive electrode particle 200. The composite positive electrode particle 200 covered by the first carbon nanotubes 40 forms a hairball-like structure.

The advantages of the first carbon nanotubes 40 are that the lithium ions are easy to be stabilized between the first carbon nanotubes 40, therefore the lithium ion conductivity can be increased. Electrons also can be easily stabilized between the first carbon nanotubes 40 to increase the lithium ion conductivity. The very high lithium ion conductivity helps the whole battery to charge and discharge quickly.

Preferably, the nanoscale amorphous carbons 45 are amorphous carbons of a Super P auxiliary agent. The first carbon nanotubes 40 and the nanoscale amorphous carbons 45 are used as an auxiliary agent. The nanoscale amorphous carbons 45 are in a form of particles, and the first carbon nanotubes 40 are in a form of long strips, and the nanoscale amorphous carbons 45 are filled in the gaps formed in the interleaving first carbon nanotubes 40 to transmit the electric charge between the first carbon nanotubes 40 through the spanning of the nanoscale amorphous carbons 45, which further increases the transmitting efficiency of the electric current.

The advantages of the present invention are that, the LMFP particle is coated by a conductive layer to increase the overall performance. The cost of LMFP is lower than the ternary oxide and the charge and discharge performance of LMFP can be applied to a specific range of applications. The conductive layer on the outer surface of the LMFP particle compensates for the lower conductivity of LMFP, and the LMFP particle are also coated with lithium ion conductor particles to enhance the overall lithium ion conductivity and electrical conductivity, resulting in a better battery performance.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An LMFP composite positive electrode particle with a high performance conductive carbon structure; the composite positive electrode particle being used in a positive electrode of a solid-state or semi-solid battery; the composite positive electrode particle comprising:
an LMFP particle;
a conductive layer coated on an outer surface of the LMFP particle; and the conductive layer including a plurality of carbon agglomerates and a plurality of lithium ion conductor particles;
wherein the carbon agglomerates are formed by a dehydration reaction of carbohydrates, or are formed by carbon skeletons and functional groups formed by a dehydration reaction of water-soluble fibers, or are formed by carbon skeletons with straight chains or side chains containing doping elements by a dehydration reaction of amino acid polymers;
wherein the lithium ion conductor particles are dispersed within the conductive layer, or near an outer side of the conductive layer, or near the outer surface of the LMFP particle;
wherein each of the lithium ion conductor particles is formed by a first oxide or phosphate capable of conducting lithium ions, or is formed by a second oxide with a garnet structure or a perovskite structure; and
wherein the conductive layer further includes a plurality of conductive carbons connected to the carbon agglomerates to cause electrons are capable of passing across different carbon agglomerates; and the conductive carbons are formed by at least one of graphite, graphene, nanoscale amorphous carbons, and carbon nanotubes with a length less than or equal to 1 μm.

2. The LMFP composite positive electrode particle with the high performance conductive carbon structure as claimed in claim 1, wherein the organic compound is selected from monosaccharide, disaccharide, oligosaccharide and polysaccharide.

3. The LMFP composite positive electrode particle with the high performance conductive carbon structure as claimed in claim 1, wherein a lithium ion conductivity of the first oxide or phosphate is higher than 10⁻⁵ S/cm (Siemens per centimeter); and the first oxide or phosphate is selected from LATP (lithium aluminum titanium phosphate) with a NASICON (sodium (Na) super ionic conductor) structure, LAGP (lithium aluminium germanium phosphate), and lithiophosphate (Li₃PO₄).

4. The LMFP composite positive electrode particle with the high performance conductive carbon structure as claimed in claim 1, wherein the second oxide with the garnet structure or the perovskite structure is selected from LLZO (Li₇La₃Zr₂O₁₂, lithium lanthanum zirconium oxide) and LLTO (lithium lanthanum titanium oxide).

5. The LMFP composite positive electrode particle with the high performance conductive carbon structure as claimed in claim 1, wherein a D50 (mass-median-diameter, MMD) value of the LMFP particle is less than 1 μm; and the LMFP particle is a polymer of monocrystalline materials or microcrystalline particles.

6. The LMFP composite positive electrode particle with the high performance conductive carbon structure as claimed in claim 1, wherein the LMFP particle is formed by LMFP (lithium manganese iron phosphate, LiMnₓFe₁₋ₓPO₄, 0.1≤x≤0.8) or LMFP doped with at least one metal.

7. The LMFP composite positive electrode particle with the high performance conductive carbon structure as claimed in claim 1, wherein the carbon agglomerates are formed by a compound including carbon, nitrogen, fluorine, phosphorus and sulfur; and the nitrogen, fluorine, phosphorus and sulfur are doped to the carbon.

8. The LMFP composite positive electrode particle with the high performance conductive carbon structure as claimed in claim 1, wherein an outer surface of each of the lithium ion conductor particles is further coated by a borate layer to cause that the lithium ion conductor particles form a plurality of lithium ion composite conductor particles; and the lithium ion composite conductor particles on the LMFP particle form a continuous layer structure or a discontinuously dispersed structure or an island-shaped structure.

9. The LMFP composite positive electrode particle with the high performance conductive carbon structure as claimed in claim 1, wherein a thickness of the conductive layer is less than or equal to 200 nm; and a size of each of the lithium ion conductor particles is less than or equal to 200 nm.

10. The LMFP composite positive electrode particle with the high performance conductive carbon structure as claimed in claim 1, wherein each of the lithium ion conductor particles is formed by at least one of LLZO (Li₇La₃Zr₂O₁₂), Ga-LLZO (gallium-doped LLZO), Cu-LLZO (copper-doped LLZO), Ta-LLZO (tantalum-doped LLZO), Sr-LLZO (strontium-doped LLZO) and Al-LLZO (aluminum-doped LLZO).

11. The LMFP composite positive electrode particle with the high performance conductive carbon structure as claimed in claim 1, wherein each of the lithium ion conductor particles is formed by Cuₐ, X_{b}-LLZO, which is LLZO doped with copper (Cu) and a metal X, wherein X is selected from gallium (Ga), tantalum (Ta), strontium (Sr), barium (Ba) and aluminum (Al), and a>0 and b>0.

12. The LMFP composite positive electrode particle with the high performance conductive carbon structure as claimed in claim 11, wherein a+b=0.25˜0.8 and a>0.1.

13. The LMFP composite positive electrode particle with the high performance conductive carbon structure as claimed in claim 1, wherein each of the lithium ion conductor particles is formed by LAGP (lithium aluminium germanium phosphate) or LATP (lithium aluminum titanium phosphate); the LAGP or LATP is selected from Li₁₊ₓAlₓA₂₋ₓ(PO₄)₃ or Li_{1+x+y}AlₓA_{2-x-y-z}M_{y}N_{z}(PO₄)₃, wherein 0.1<x≤0.8, 0≤y≤0.2, 0≤z≤0.2, A is germanium (Ge) or titanium (Ti), M is trivalent cation, and N is tetravalent cation.

14. The LMFP composite positive electrode particle with the high performance conductive carbon structure as claimed in claim 1, wherein an outer surface of the composite positive electrode particle is coated by a carbon material; and the carbon material includes a plurality of first carbon nanotubes.

15. The LMFP composite positive electrode particle with the high performance conductive carbon structure as claimed in claim 14, wherein the carbon material further includes a plurality of nanoscale amorphous carbons; and a size of each of the nanoscale amorphous carbons is 10 nm to nm.

16. The LMFP composite positive electrode particle with the high performance conductive carbon structure as claimed in claim 15, wherein the first carbon nanotubes include a plurality of short chain carbon nanotubes and a plurality of long chain carbon nanotubes; a length of each of the short chain carbon nanotubes is 0.2 μm to 1 μm; and a length of each of the long chain carbon nanotubes is 1 μm to 3 μm.

17. The LMFP composite positive electrode particle with the high performance conductive carbon structure as claimed in claim 16, wherein a ratio of a weight of the short chain carbon nanotubes and a weight of the long chain carbon nanotubes is 10:1 to 2:1; and a ratio of a weight of the first carbon nanotubes and a weight of the nanoscale amorphous carbons is 1:1 to 1:10.

18. The LMFP composite positive electrode particle with the high performance conductive carbon structure as claimed in claim 15, wherein the nanoscale amorphous carbons are amorphous carbons of a Super P auxiliary agent; and the nanoscale amorphous carbons are filled in the gaps formed in the first carbon nanotubes.
